(19) United States
(12) Patent Application Publication
(10) Pub. No.: US 2026/0328714 A1
(43) Pub. Date: Oct. 22, 2026

(54) WORKPIECE INSPECTION USING DESIGN INFORMATION TO DETERMINE DEFECT ATTRIBUTES

(71) Applicant: KLA Corporation, Milpitas, CA (US)

(72) Inventors: Surajit Mondal, Bankura (IN); Rahul Prakash, Bihar (IN)

(21) Appl. No.: 19/411,237

(22) Filed: Dec. 6, 2025

(30) Foreign Application Priority Data
Apr. 17, 2025 (IN) 202541037034

(51) Int. Cl. G01N 23/2251; G06T 7/00; G06T 7/73

(52) U.S. Cl. CPC G01N 23/2251; G06T 7/0006; G06T 7/001; G06T 7/74; G01N 2223/6116; G06T 2207/10061; G06T 2207/20081; G06T 2207/20084; G06T 2207/30148; G06T 2207/30164

(57) ABSTRACT

A defect in an electron beam image of a workpiece is identified using a deep learning detection model. The workpiece may be a semicondutor wafer. The electron beam image is aligned to a design image of the workpiece. A design polygon is then extracted from the design image at a location in the design image corresponding to a location of the defect in the electron beam image. An attribute of the defect is then determined using the design polygon.

### CROSS-REFERENCE TO RELATED APPLICATIONS

This application claims priority to Indian Patent Application number 202541037034 filed Apr. 17, 2025, the disclosure of which is hereby incorporated by reference.

### FIELD OF THE DISCLOSURE

This disclosure relates to workpiece inspection using an electron beam.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it maximizes the return-on-investment for a semiconductor manufacturer.

Fabricating semiconductor devices, such as logic and memory devices, typically includes processing workpiece like a semiconductor wafer using a large number of fabrication processes to form various features and multiple levels of the semiconductor devices. For example, lithography is a semiconductor fabrication process that involves transferring a pattern from a reticle to a photoresist arranged on a semiconductor wafer. Additional examples of semiconductor fabrication processes include, but are not limited to, chemical-mechanical polishing (CMP), etching, deposition, and ion implantation. An arrangement of multiple semiconductor devices fabricated on a single semiconductor wafer may be separated into individual semiconductor devices.

Inspection processes are used at various steps during semiconductor manufacturing to detect defects on workpieces to promote higher yield in the manufacturing process and, thus, higher profits. Inspection has always been an important part of fabricating semiconductor devices such as integrated circuits (ICs). However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary because even relatively small defects may cause unwanted aberrations in the semiconductor devices.

As design rules shrink, however, semiconductor manufacturing processes may be operating closer to the limitation on the performance capability of the processes. In addition, smaller defects can have an impact on the electrical parameters of the device as the design rules shrink, which drives more sensitive inspections. As design rules shrink, the population of potentially yield-relevant defects detected by inspection grows dramatically, and the population of nuisance defects detected by inspection also increases dramatically. Therefore, more defects may be detected on the wafers, and correcting the processes to eliminate all of the defects may be difficult and expensive. Determining which of the defects actually have an effect on the electrical parameters of the devices and the yield may allow process control methods to be focused on those defects while largely ignoring others. Furthermore, at smaller design rules, process-induced failures, in some cases, tend to be systematic. That is, process-induced failures tend to fail at predetermined design patterns often repeated many times within the design. Elimination of spatially-systematic, electrically-relevant defects can have an impact on yield.

Current inspection methods can generate a prediction map by assigning a probability score to each pixel in an image. Only pixels having a probability value higher than an assigned threshold value are reported as defect candidates during operation. Pixels below the threshold value do not become part of the defect mask, which limits the image to only the potential defects. The defect mask includes only the pixels above the threshold value. Attributes are determined from the defect mask, but the shape and/or size of the features in the defect mask may not represent the true size of the defect. Consequently, defect attributes determined from the features in the defect mask may not be correct. Since this is a probability-based approach, the defect mask that is generated varies between inspections although the feature size generally remains the same. Attributes determined between inspections may not be consistent, which results in repeatability issues. Improved systems and techniques are needed.

### BRIEF SUMMARY OF THE DISCLOSURE

A method is provided in a first embodiment. The method includes identifying a defect in an electron beam image of a workpiece using a deep learning detection model. The workpiece may be a semiconductor wafer. The electron beam image is aligned to a design image of the workpiece using a processor. Using a processor, a design polygon is extracted from the design image at a location in the design image corresponding to a location of the defect in the electron beam image. An attribute of the defect is determined using the design polygon using the processor. The attribute may be one or more of average grey level, defect site, grey level difference of the defect using the design polygon against a reference, shape of the design polygon, or size of the design polygon.

The method may include ellipse fitting on the design polygon.

The method may include performing inspection of the workpiece using the attribute of the defect.

The method may include generating the design image from a design file for the workpiece.

The method may include directing an electron beam at the workpiece; receiving electrons from the workpiece at a detector; and generating the electron beam image using data from the detector.

An inspection system is provided in a second embodiment. The inspection system includes an electron beam source that generates an electron beam; a stage configured to hold a workpiece in a path of the electron beam; a detector configured to receive electrons from the workpiece; and a processor in electronic communication with the detector. The workpiece may be a semiconductor wafer. The processor is configured to generate an electron beam image of the workpiece using data from the detector; identify a defect in the electron beam image using a deep learning detection model; align the electron beam image to a design image of the workpiece; extract a design polygon from the design image at a location in the design image corresponding to a location of the defect in the electron beam image; and determine an attribute of the defect using the design polygon. The attribute may be one or more of average grey level, defect site, grey level difference of the defect using the design polygon against a reference, shape of the design polygon, or size of the design polygon.

The processor may be further configured to perform ellipse fitting on the design polygon.

The processor may be further configured to perform inspection of the workpiece using the attribute of the defect.

A non-transitory computer-readable storage medium is provided in a third embodiment. The non-transitory computer-readable storage medium includes one or more programs for executing the following steps on one or more computing devices. The steps include identifying a defect in an electron beam image of a workpiece using a deep learning detection model; aligning the electron beam image to a design image of the workpiece; extracting a design polygon from the design image at a location in the design image corresponding to a location of the defect in the electron beam image; and determining an attribute of the defect using the design polygon. The workpiece may be a semiconductor wafer. The attribute may be one or more of average grey level, defect site, grey level difference of the defect using the design polygon against a reference, shape of the design polygon, or size of the design polygon.

The steps may further include ellipse fitting on the design polygon.

The steps may further include performing inspection of the workpiece using the attribute of the defect.

### DESCRIPTION OF THE DRAWINGS

For a fuller understanding of the nature and objects of the disclosure, reference should be made to the following detailed description taken in conjunction with the accompanying drawings, in which:

FIG. 1 is a flowchart illustrating a method in accordance with the present disclosure;

FIG. 2 is an exemplary electron beam image;

FIG. 3 is an exemplary deep learning detection mask image;

FIG. 4 is an exemplary design image;

FIG. 5 is an exemplary aligned design image;

FIG. 6 is an image showing common design polygons corresponding to the deep learning detection mask image of FIG. 3;

FIG. 7 is an image showing ellipses fitted on the design polygons of FIG. 6;

FIG. 8 is an exemplary deep learning probability defect;

FIG. 9 is an exemplary electron beam image showing the defect shape corresponding to FIG. 8;

FIG. 10 is an exemplary design polygon of the defect shape corresponding to FIG. 9; and

FIG. 11 is an embodiment of an electron beam inspection system in accordance with the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

Embodiments disclosed herein improve defect detection on a workpiece by using design information for more accurate attribute determination. The design is an intended pattern that is supposed to be printed on the workpiece to form a device. Consequently, inspection based on the design usually have the best size matching with the defect in the electron beam image. Grey levels tend to be more consistent. Repeatability for scanning electron microscope (SEM) workpiece inspection and other electron beam inspection systems is often better when performing defect detection and analyzing defect attributes.

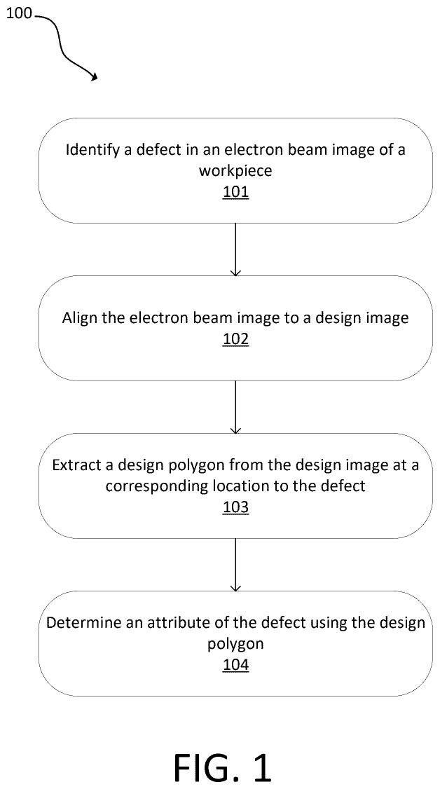

FIG. 1 is a flowchart illustrating a method 100. The steps of the method 100 may use a processor. In the method 100, a defect in an electron beam image of a workpiece can be identified at 101 using a deep learning detection model. For example, the workpiece can be a semiconductor wafer, a flat panel, or another type of substrate.

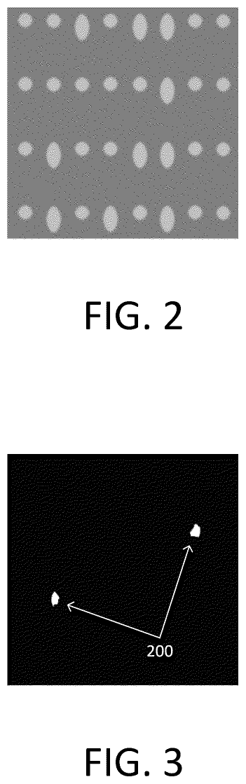

In an instance, an electron beam is directed at the workpiece. Electrons from the workpiece are received at a detector. Data from the detector can be used to generate the electron beam image. An exemplary electron beam image is shown in FIG. 2. The identified defects 200 from the exemplary electron beam image of FIG. 2 are shown in FIG. 3. These defects may be caused by process issues during manufacturing of the workpiece. A deep learning detection model can be used to determine the presence of one or more defects. The two shapes in the defect mask of FIG. 3 were pixels that exceeded a threshold value. Only the pixels that exceeded the threshold value are part of the defect mask. The threshold value can be determined based on a dimension of the defect and its signal strength.

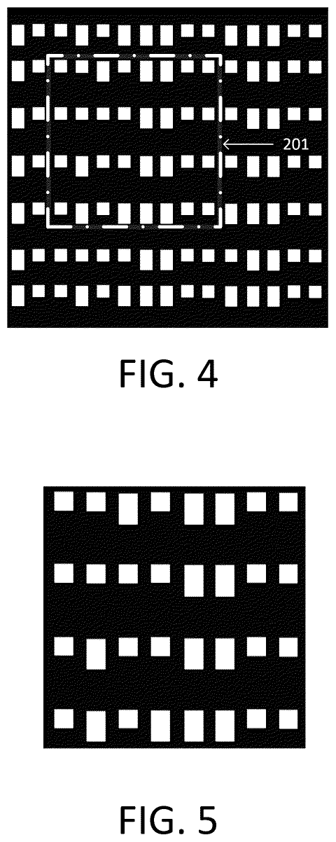

Turning back to FIG. 1, the electron beam image is aligned to a design image of the workpiece at 102. The electron beam image is aligned to a design image of the workpiece by tracing the design image on the electron beam image. A correlation score can be used to determine if the alignment is performed without a tolerance. For example, FIG. 4 is an exemplary design image. The highlighted region 201 with the dotted-dashed line inside the exemplary design image corresponds with the electron beam image of FIG. 2. The design image can be cropped and/or aligned to the electron beam image. FIG. 5 is an exemplary aligned design image. The exemplary aligned design image in FIG. 5 corresponds to the electron beam image of FIG. 2. Thus, the aligned design image in FIG. 5 may include the same devices and/or structures as the electron beam image of FIG. 2. The aligned design image in FIG. 5 also may be the same size as the electron beam image of FIG. 2.

The design image can be generated from a design file for the workpiece. For example, an algorithm can be used to create a design image from a design file. The design file includes structural details of the workpiece or a device on the workpiece. The design image is a greyscale or binary image based on the design file that shows an ideal or intended device or structure on the workpiece in a simulated image.

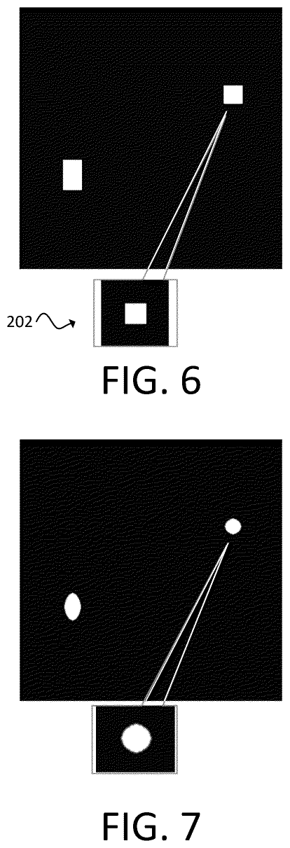

Turning back to FIG. 1, a design polygon is extracted from the design image at a location in the design image corresponding to a location of the defect in the electron beam image at 103. An aligned design image is compared with the electron beam image and deep learning detection mask image based on the location of the mask image, which allows extraction of the design polygon. This is shown in FIG. 6. FIG. 6 is an image showing common design polygons corresponding to the deep learning detection mask image of FIG. 3. The zoomed in portion 202 shows that the shapes of the defect mask in FIG. 3 were replaced with the design polygon in the design image of FIG. 5. These design polygons are substituted at the same location on the design mask.

Turning back to FIG. 1, an attribute of the defect is determined at 104 using the design polygon using the processor. The attribute is one or more of average grey level, defect site, grey level difference of the defect using the design polygon against a reference, shape of the design polygon, size of the design polygon, or other features. Inspection can be performed using the attribute of the design polygon, which can be used to determine if a defect is present on the workpiece.

The design polygon can be processed. For example, ellipse fitting can be performed on the design polygon. Ellipse fitting uses the dimension of the design polygons and fits an ellipse based on the design polygons. The ellipse fitting may provide a closer approximately of the features in the electron microscope image. This is shown in FIG. 7. The design polygons of FIG. 6 are processed using ellipse fitting to have the shape shown in FIG. 7. Other processing steps can be performed. The modified shape after processing may be used as final mask for determining attributes of the defect, which may be more accurate and provided improved repeatable results.

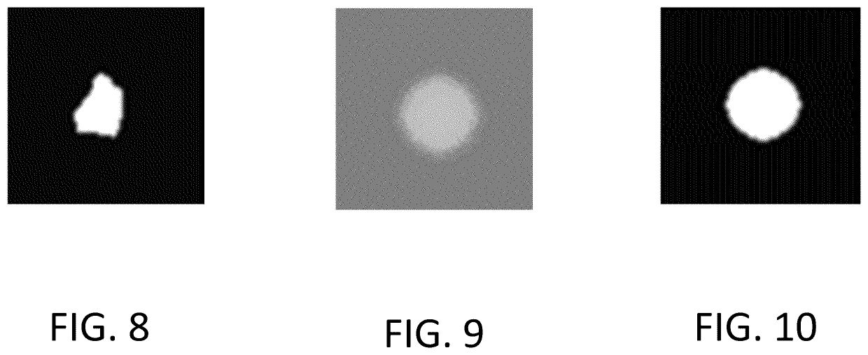

A comparison is shown in FIGS. 8-10. FIG. 8 is an exemplary deep learning probability defect in a defect mask, which is generated from pixels in an electron beam image. This can be difficult to measure or analyze because it may not represent the actual shape of the defect. FIG. 9 is an exemplary electron beam image showing the defect shape corresponding to FIG. 8. FIG. 9 shows the actual structure on the workpiece. As shown in FIG. 9, the actual shape in the electron beam image does not match the defect mask. The defect mask is generated based on defect detection using a deep learning model, which means that the defect mask is not always the actual shape of the feature in the electron beam image. FIG. 10 is an exemplary design polygon of the defect shape corresponding to FIG. 9. Replacing the shape of the feature in the defect mask of FIG. 8 with the design polygons in FIG. 10 during inspection will provide a more accurate, repeatable inspection.

Improvements using the embodiments disclosed herein were demonstrated in an experiment. The embodiment disclosed herein used in the experiment used clusters of pixels on the mask image representing the defect. The difference in grey level was compared against different runs in a series of repeated runs.

| Difference in Grey Level | Difference in Grey Level of |
|---|---|
| of Each Defect in Two Runs | Each Defect in Two Runs Using |
| Using Previous Approach | Embodiment Disclosed Herein |
| 29.7 | 6.82 |
| 21.7 | 0.69 |
| 25.98 | −0.29 |
| 20.12 | 9.88 |
| 0.1 | −1.58 |
| 1.93 | 3.33 |
| 6.02 | 6.42 |
| −5.16 | −2.73 |
| 23.16 | 9.95 |
| 2.59 | 8.94 |

In summary, seven of the ten defects had better repeatability of attributes between the two runs using an embodiment disclosed herein. Run-to-run variation of the grey level attribute was reduced to less than 9.95.

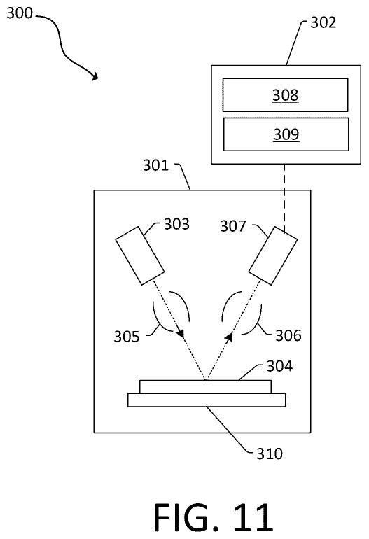

FIG. 11 is a block diagram of an embodiment of a system 300. The system 300 includes a workpiece inspection system (which includes the electron column 301) configured to generate images of a wafer 304.

The workpiece inspection system includes an output acquisition subsystem that includes at least an energy source and a detector. The output acquisition subsystem may be an electron beam-based output acquisition subsystem. For example, in one embodiment, the energy directed to the wafer 304 includes electrons, and the energy detected from the wafer 304 includes electrons. In this manner, the energy source may be an electron beam source. In one such embodiment shown in FIG. 11, the output acquisition subsystem includes electron column 301, which is coupled to computer subsystem 302. A stage 310 may hold the wafer 304.

As also shown in FIG. 11, the electron column 301 includes an electron beam source 303 configured to generate electrons that are focused to wafer 304 by one or more elements 305. The electron beam source 303 may include, for example, a cathode source or emitter tip. The one or more elements 305 may include, for example, a gun lens, an anode, a beam limiting aperture, a gate valve, a beam current selection aperture, an objective lens, and a scanning subsystem, all of which may include any such suitable elements known in the art.

Electrons returned from the wafer 304 (e.g., secondary electrons) may be focused by one or more elements 306 to detector 307. One or more elements 306 may include, for example, a scanning subsystem, which may be the same scanning subsystem included in element(s) 305.

The electron column 301 also may include any other suitable elements known in the art.

Although the electron column 301 is shown in FIG. 11 as being configured such that the electrons are directed to the wafer 304 at an oblique angle of incidence and are scattered from the wafer 304 at another oblique angle, the electron beam may be directed to and scattered from the wafer 304 at any suitable angles. In addition, the electron beam-based output acquisition subsystem may be configured to use multiple modes to generate images of the wafer 304 (e.g., with different illumination angles, collection angles, etc.). The multiple modes of the electron beam-based output acquisition subsystem may be different in any image generation parameters of the output acquisition subsystem.

Computer subsystem 302 may be coupled to detector 307 as described above. The detector 307 may detect electrons returned from the surface of the wafer 304 thereby forming electron beam images of the wafer 304. The electron beam images may include any suitable electron beam images. Computer subsystem 302 may be configured to perform any of the functions described herein using the output of the detector 307 and/or the electron beam images. Computer subsystem 302 may be configured to perform any additional step(s) described herein. A system 300 that includes the output acquisition subsystem shown in FIG. 11 may be further configured as described herein.

It is noted that FIG. 11 is provided herein to generally illustrate a configuration of an electron beam-based output acquisition subsystem that may be used in the embodiments described herein. The electron beam-based output acquisition subsystem configuration described herein may be altered to optimize the performance of the output acquisition subsystem as is normally performed when designing a commercial output acquisition system. In addition, the systems described herein may be implemented using an existing system (e.g., by adding functionality described herein to an existing system). For some such systems, the methods described herein may be provided as optional functionality of the system (e.g., in addition to other functionality of the system). Alternatively, the system described herein may be designed as a completely new system.

Although the output acquisition subsystem is described above as being an electron beam-based output acquisition subsystem, the output acquisition subsystem may be an ion beam-based output acquisition subsystem. Such an output acquisition subsystem may be configured as shown in FIG. 11 except that the electron beam source may be replaced with any suitable ion beam source known in the art. In addition, the output acquisition subsystem may be any other suitable ion beam-based output acquisition subsystem such as those included in commercially available focused ion beam (FIB) systems, helium ion microscopy (HIM) systems, and secondary ion mass spectroscopy (SIMS) systems.

The computer subsystem 302 includes a processor 308 and an electronic data storage unit 309. The processor 308 may include a microprocessor, a microcontroller, or other devices. The processor 308 may be CPU, GPU, or a combination thereof.

The computer subsystem 302 may be coupled to the components of the system 300 in any suitable manner (e.g., via one or more transmission media, which may include wired and/or wireless transmission media) such that the processor 308 can receive output. The processor 308 may be configured to perform a number of functions using the output. The workpiece inspection system can receive instructions or other information from the processor 308. The processor 308 and/or the electronic data storage unit 309 optionally may be in electronic communication with another workpiece inspection system, a wafer metrology system, or a wafer review system (not illustrated) to receive additional information or send instructions.

The processor 308 is in electronic communication with the workpiece inspection system, such as the detector 307. The processor 308 may be configured to process images generated using measurements from the detector 307 or perform inspection using the images generated using measurements from the detector 307. For example, the processor 308 may perform embodiments of the method 100.

The computer subsystem 302, other system(s), or other subsystem(s) described herein may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked system.

The processor 308 and electronic data storage unit 309 may be disposed in or otherwise part of the system 300 or another device. In an example, the processor 308 and electronic data storage unit 309 may be part of a standalone control unit or in a centralized quality control unit. Multiple processors 308 or electronic data storage units 309 may be used.

The processor 308 may be implemented in practice by any combination of hardware, software, and firmware. Also, its functions as described herein may be performed by one unit, or divided up among different components, each of which may be implemented in turn by any combination of hardware, software and firmware. Program code or instructions for the processor 308 to implement various methods and functions may be stored in readable storage media, such as a memory in the electronic data storage unit 309 or other memory.

If the system 300 includes more than one computer subsystem 302, then the different subsystems may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 308 may be configured to perform a number of functions using the output of the system 300 or other output. For instance, the processor 308 may be configured to send the output to an electronic data storage unit 309 or another storage medium. The processor 308 may be further configured as described herein.

The processor 308 or computer subsystem 302 may be part of a defect review system, an inspection system, a metrology system, or some other type of system. Thus, the embodiments disclosed herein describe some configurations that can be tailored in a number of manners for systems having different capabilities that are more or less suitable for different applications.

The processor 308 may be configured according to any of the embodiments described herein. The processor 308 also may be configured to perform other functions or additional steps using the output of the system 300 or using images or data from other sources.

The processor 308 may be communicatively coupled to any of the various components or sub-systems of system 300 in any manner known in the art. Moreover, the processor 308 may be configured to receive and/or acquire data or information from other systems (e.g., inspection results from an inspection system such as a review system, a remote database including design data and the like) by a transmission medium that may include wired and/or wireless portions. In this manner, the transmission medium may serve as a data link between the processor 308 and other subsystems of the system 300 or systems external to system 300.

Various steps, functions, and/or operations of system 300 and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random access memory, a magnetic or optical disk, a non-volatile memory, a solid state memory, a magnetic tape, and the like. A carrier medium may include a transmission medium such as a wire, cable, or wireless transmission link. For instance, the various steps described throughout the present disclosure may be carried out by a single processor 308 (or computer subsystem 302) or, alternatively, multiple processors 308 (or multiple computer subsystems 302). Moreover, different sub-systems of the system 300 may include one or more computing or logic systems. Therefore, the above description should not be interpreted as a limitation on the present disclosure but merely an illustration.

Generally speaking, deep learning (also known as deep structured learning, hierarchical learning or deep machine learning) is a branch of machine learning based on a set of algorithms that attempt to model high level abstractions in data. In a simple case, there may be two sets of neurons: ones that receive an input signal and ones that send an output signal. When the input layer receives an input, it passes on a modified version of the input to the next layer. In a deep network, there are many layers between the input and output, allowing the algorithm to use multiple processing layers, composed of multiple linear and non-linear transformations.

Deep learning is part of a broader family of machine learning methods based on learning representations of data. An observation (e.g., a feature to be extracted for reference) can be represented in many ways such as a vector of intensity values per pixel or in a more abstract way like a set of edges, regions of particular shape, etc. Some representations are better than others at simplifying the learning task.

In an embodiment, the deep learning model is configured as a neural network. In a further embodiment, the deep learning model may be a deep neural network with a set of weights that model the world according to the data that it has been fed to train it. Neural networks can be generally defined as a computational approach based on a relatively large collection of neural units loosely modeling the way a biological brain solves problems with relatively large clusters of biological neurons connected by axons. Each neural unit is connected with many others, and links can be enforcing or inhibitory in their effect on the activation state of connected neural units. These systems are self-learning and trained rather than explicitly programmed and excel in areas where the solution or feature detection is difficult to express in a traditional computer program.

Neural networks typically include multiple layers, and the signal path traverses from front to back. The goal of the neural network is to solve problems in the same way that the human brain would, although several neural networks are much more abstract. Modern neural network projects typically work with a few thousand to a few million neural units and millions of connections. The neural network may have any suitable architecture and/or configuration known in the art.

A neural network for deep learning can be either supervised or unsupervised. A supervised neural network uses labeled data sets during training whereas an unsupervised neural network involves analysis of unlabeled data sets. In an embodiment, a deep learning model may be based on architectures such as residual nets, convolution neural networks, deep belief networks and recurrent neural networks. In an architecture based on convolutions, each layer performs certain convolution operations based on one or more kernels (typically defined by weights associated with the kernels). During the training process, the deep learning model may be modified by adjusting the kernels (i.e. changing the kernel weight values).

A convolutional neural network typically has several layers chained together in a subsequent manner, such that information flows from input to output. Effectively, each layer takes in a tensor Tᵢₙ and outputs a new tensor Tₒᵤₜ. The input tensor is convolved with a kernel tensor W, the resulting convolution may be increased with a bias vector and passed through an activation function such as a rectified linear unit (ReLU).

The deep learning model needs to be trained, and object (or features within an image) labels may be domain specific. As such, in an embodiment, a set of training data is generated or obtained based on some ground truth. Such ground truth may include a set of raw input images together with output images, where each pixel has been assigned an object label. By using data augmentation (e.g., taking random crops out of the ground truth and translating, rotating, scaling, etc.) a training set with sufficient variation and volume may be generated. In an instance, supervised learning based on user-defined inputs is used to train the deep learning model. Pixels in the image that correspond to defects are marked as defect and fed to deep learning model for training and the deep learning model learns them based on these inputs.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A method comprising:
identifying a defect in an electron beam image of a workpiece using a deep learning detection model;
aligning the electron beam image to a design image of the workpiece using a processor;
extracting, using a processor, a design polygon from the design image at a location in the design image corresponding to a location of the defect in the electron beam image; and
determining, using the processor, an attribute of the defect using the design polygon.

2. The method of claim 1, further comprising ellipse fitting on the design polygon.

3. The method of claim 1, wherein the attribute is one or more of average grey level, defect site, grey level difference of the defect using the design polygon against a reference, shape of the design polygon, or size of the design polygon.

4. The method of claim 1, further comprising performing inspection of the workpiece using the attribute of the defect.

5. The method of claim 1, further comprising generating the design image from a design file for the workpiece.

6. The method of claim 1, further comprising:
directing an electron beam at the workpiece;
receiving electrons from the workpiece at a detector; and
generating the electron beam image using data from the detector.

7. The method of claim 1, wherein the workpiece is a semiconductor wafer.

8. An inspection system comprising:
an electron beam source that generates an electron beam;
a stage configured to hold a workpiece in a path of the electron beam;
a detector configured to receive electrons from the workpiece; and
a processor in electronic communication with the detector, wherein the processor is configured to:
generate an electron beam image of the workpiece using data from the detector;
identify a defect in the electron beam image using a deep learning detection model;
align the electron beam image to a design image of the workpiece;
extract a design polygon from the design image at a location in the design image corresponding to a location of the defect in the electron beam image; and
determine an attribute of the defect using the design polygon.

9. The inspection system of claim 8, wherein the processor is further configured to perform ellipse fitting on the design polygon.

10. The inspection system of claim 8, wherein the attribute is one or more of average grey level, defect site, grey level difference of the defect using the design polygon against a reference, shape of the design polygon, or size of the design polygon.

11. The inspection system of claim 8, wherein the processor is further configured to perform inspection of the workpiece using the attribute of the defect.

12. The inspection system of claim 8, wherein the workpiece is a semiconductor wafer.

13. A non-transitory computer-readable storage medium, comprising one or more programs for executing the following steps on one or more computing devices:
identifying a defect in an electron beam image of a workpiece using a deep learning detection model;
aligning the electron beam image to a design image of the workpiece;
extracting a design polygon from the design image at a location in the design image corresponding to a location of the defect in the electron beam image; and
determining an attribute of the defect using the design polygon.

14. The non-transitory computer-readable storage medium of claim 13, wherein the steps further include ellipse fitting on the design polygon.

15. The non-transitory computer-readable storage medium of claim 13, wherein the attribute is one or more of average grey level, defect site, grey level difference of the defect using the design polygon against a reference, shape of the design polygon, or size of the design polygon.

16. The non-transitory computer-readable storage medium of claim 13, wherein the steps further include performing inspection of the workpiece using the attribute of the defect.

17. The non-transitory computer-readable storage medium of claim 13, wherein the workpiece is a semiconductor wafer.
